(19) United States
(12) Patent Application Publication
(10) Pub. No.: US 2020/0175895 A1
(43) Pub. Date: Jun. 4, 2020

(54) Labels for a cooler

(71) Applicant: Larry Durst, Monroe, OH (US)

(72) Inventor: Larry Durst, Monroe, OH (US)

(21) Appl. No.: 15/796,396

(22) Filed: Oct. 27, 2017

(51) Int. Cl. G09F 3/20

(52) U.S. Cl. CPC G09F 3/202; G09F 2003/0272; G09F 3/201

(57) ABSTRACT

The current invention is a pack small plastic label holders that adhere to the top or any side of any cooler. A label can consist of a piece of cardboard cut from a cardboard label will be cut out of a cardboard box and inserted into the holders. The label holders adhere to the top or any side of any cooler and are reusable. When the contents change the new labels are filled out and slid inside the label holder.

### CROSS-REFERENCES TO RELATED APPLICATIONS (IF ANY)

None.

### BACKGROUND

### 1. Field of the Invention

The present invention relates generally to labels and more specifically labels to let someone know what is in a cooler.

### 2. Description of Prior Art

It can be awkward to bounce around from cooler to cooler at a party in search of the drinks that someone is looking for. At big events like block parties or graduation parties, there can be multiple coolers sitting around and it is a guessing game trying to figure out what is where. Opening each cooler looking for a certain idea raises the heat of the cooler increasing the chance for spoilage and reduces the cooling effect of the cooler.

There is still room for improvement in the art.

### SUMMARY OF THE INVENTION

The current invention is a pack comprising a 3-sleeve plastic label holders that adhere to the top or any side of any cooler. A label can consist of a piece of cardboard cut from a cardboard label cut out of a cardboard box and inserted into the holders. Other types of labels can also be used. People can walk over to the coolers and quickly check each card without having to open every one or dig around inside to see what is inside. The label holders adhere to the top or any side of any cooler and are reusable. When the contents change from party to party, all a user has to do is fill in the new labels and slide them inside the label holder.

### BRIEF DESCRIPTION OF THE DRAWINGS

Without restricting the full scope of this invention, the preferred form of this invention is illustrated in the following drawings:

FIG. 1 displays the labels on the cooler;

FIG. 2 shows another view of the labels on the cooler;

FIG. 3 shows a top view of the cooler with the labels;

FIG. 4 shows a side view of the cooler with the labels;

FIG. 5 shows the label going into one of the label holders in the pack; and

FIG. 6 shows the adhesive side of the pack of label holders.

### DESCRIPTION OF THE PREFERRED EMBODIMENT

There are a number of significant design features and improvements incorporated within the invention.

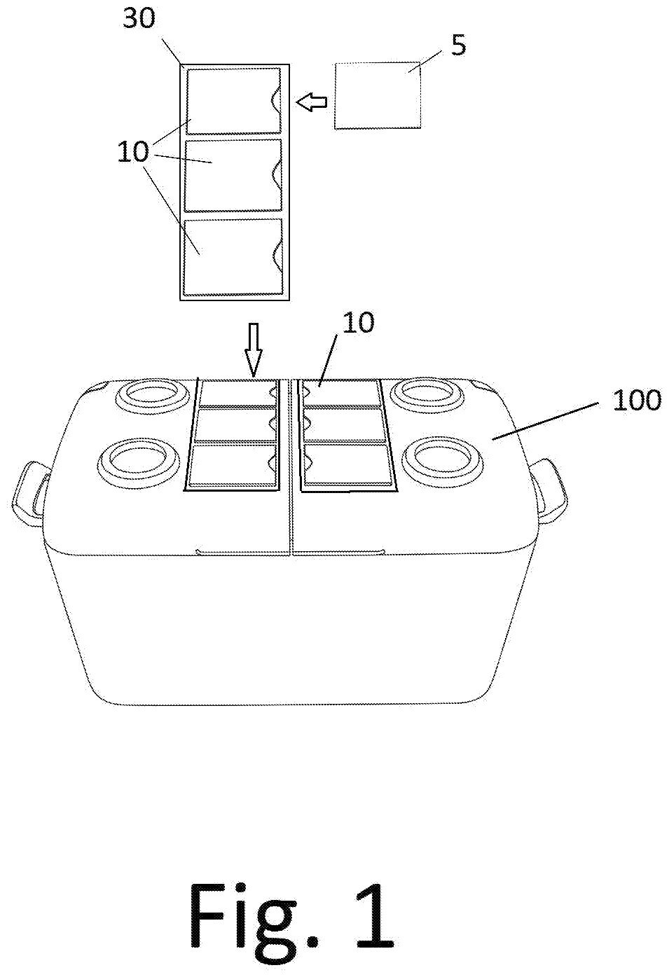

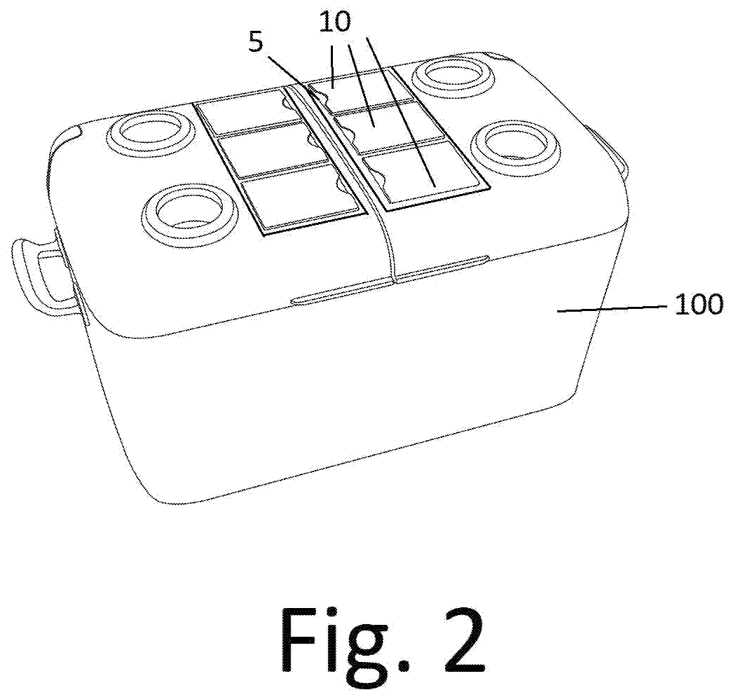

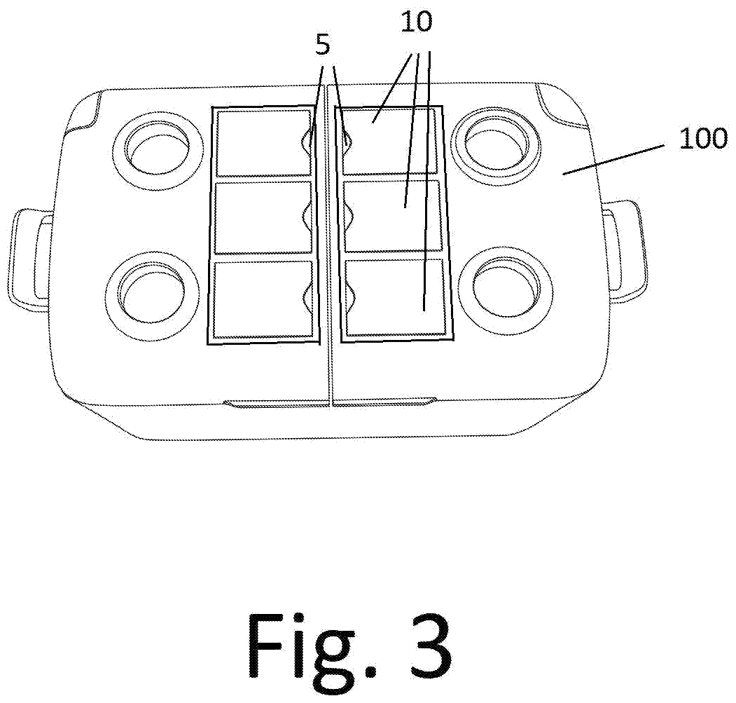

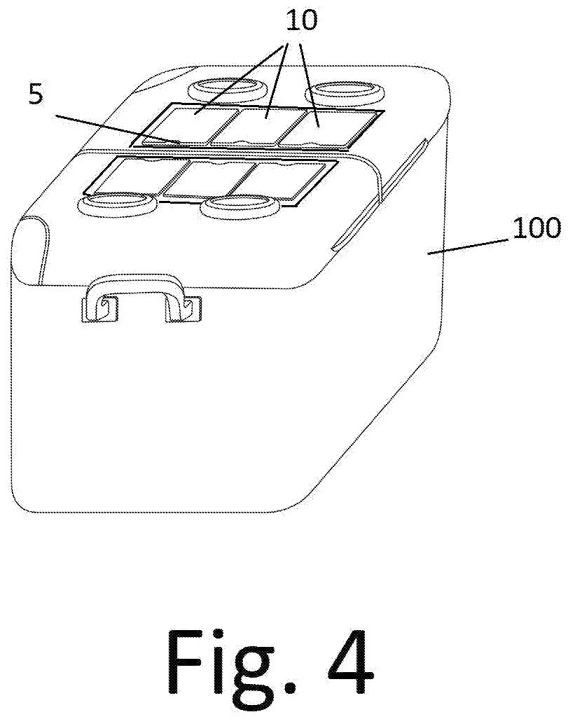

In reference to FIGS. 1 through 6, the present invention consists of a plurality of labels 5 and label holders 10 on a cooler 100.

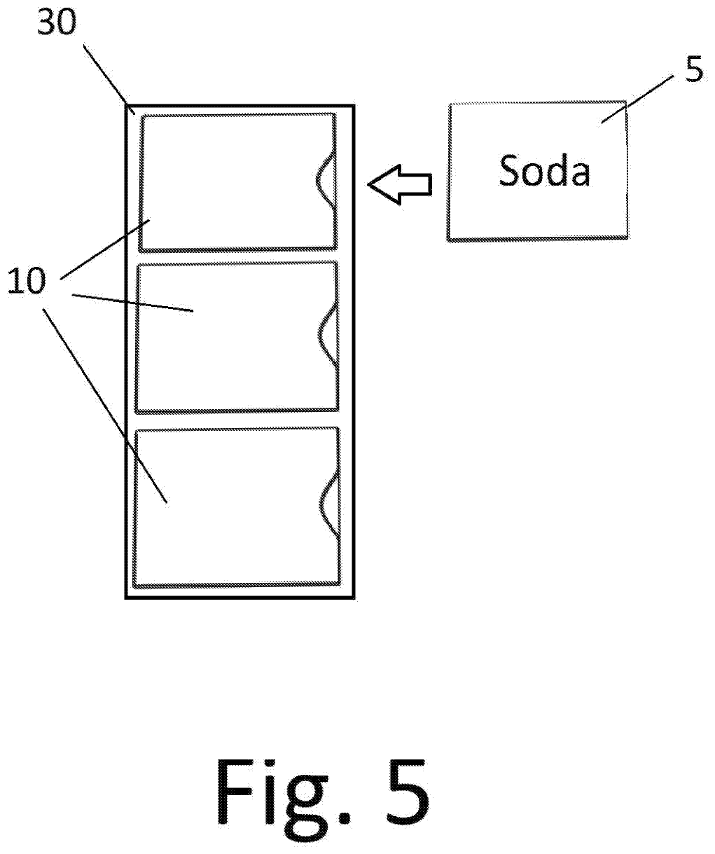

The current invention is a pack 30 of a plurality of plastic label holders 10 attached to a cooler and labels 5 that slide into the holders 10 as shown in FIG. 5. In the preferred embodiment, a pack 30 is a 3-sleeve label holder 10. Multiple label holders 10 can be attached to the cooler 100 has shown in FIGS. 1 through 4 which shows two packs of three label holders 10 facing each other.

The label holders 10 adhere to any side of any cooler 100. A label 5, which can consist of a piece of cardboard cut from a cardboard label cut out of a cardboard box packaging and inserted into the holders 10. People can walk over to the coolers and quickly check each card without having to open every one or dig around inside to see what is inside.

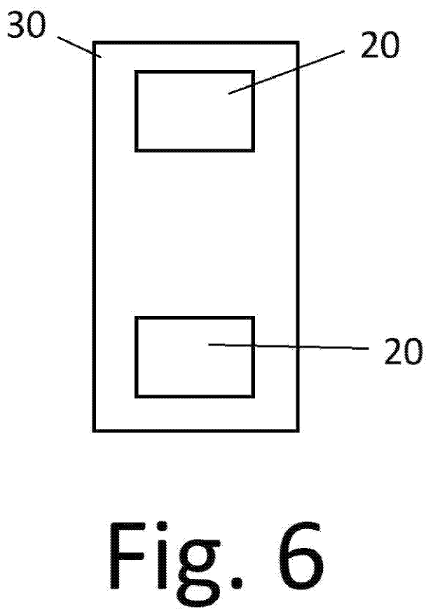

The label holders 10 have a clear plastic front with an opening on one side where the label 5 is slide into. The back can be a solid color like black or also be made of a clear plastic. The pack 30 of label holders 10 can adhere to the top or any side of any cooler and are reusable. The pack 30 has an adhesive 20 on its back as shown in FIG. 6 which is used to adhere the pack 30 to the cooler 100.

The labels 5 which in the preferred embodiment consists of a piece of cardboard cut from a cardboard label cut out of a cardboard box. They also can be made of a rigid cardboard or paper and identifies an item or items within the cooler 100. The label 5 can have a writable surface were the items in the cooler 100 can be written. They also can have symbols on them or even specific trademarks or tradenames for a specific type of beer or soda. In one embodiment, the labels 5 would be made from an erasable material or have an erasable surface so that they could be reused over and over again.

The backs of the label holders 10 or the labels 5 themselves can be color coded, for example, red means beer, blue means soda and green means food.

The labels holders 10 are attached to the outside of the cooler 100 so a user can see what is inside the coolers before opening the lid.

In the preferred embodiment, the packs 30 would have three label holders 10 and be sold in sets of two packs 30 to a package.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. In a cooler having a hollow body forming a cavity for receiving contents and a lid for alternately closing the cavity and opening the cavity in order to access the contents, wherein the improvement comprises:
at least one label holding sleeve consisting essential of:
a transparent outer film forming a clear front having a first rectangular perimeter;
a rectangular planar back secured about a portion of a second perimeter to said first rectangular perimeter; and
an opening formed along only one side;
an adhesive on a rear surface of said planar back and attachable to said lid; and
a label adapted to fit within said holding sleeve in a manner accessing or egressing through that slides into the opening;
where said label has an indicia on a surface facing said transparent outer film for identifying at least a portion of said contents.

2. (canceled)

3. The improvement of claim 1, wherein said label further comprises a piece of cardboard.

4. The improvement of claim 3, wherein said indicia is written.

5. The improvement of claim 3, wherein said indicia is color.

6. (canceled)

7. The improvement of claim 1, wherein said rectangular planar back further comprises a color functioning as a code for identification of said contents.

8. (canceled)

9. The improvement of claim 1, wherein said surface facing said transparent outer film for identifying at least a portion of said contents further comprises an erasable surface.

10. The improvement of claim 9, wherein said indicia is erasable.

11. The improvement of claim 1, further comprising a plurality of said holding sleeves.

12. A cooler content identification system comprising:
a cooler lid forming an attachment surface;
a label holding sleeve having an outer window forming a transparent front and covering a rectangular planar back;
a sleeve opening formed along a side of said label holding sleeve;
an adhesive on a rear surface of said rectangular planar back and attached to said attachment surface; and
a label adapted to fit within said label holding sleeve through said sleeve opening; and
an indicia on an outer label surface and visible through said window, wherein said indicia is adapted for identifying at least a portion contents within the cooler.

13. The cooler contents identification system of claim 12, wherein said label is formed of cardboard.

14. The cooler contents identification system of claim 12, wherein said indicia on said outer label surface is erasable.

15. The cooler contents identification system of claim 13, wherein
said label is formed of a portion of a paper or cardboard packaging obtained with said at least a portion contents within the cooler; and
said indicia comprises a printed matter obtained with said paper or cardboard packaging.

16. A method for identification of contents contained within a cooler comprising:
a. removing contents from a paper or cardboard packaging and placing said contents within a cooler;
b. obtaining a cooler content identification system of claim 12;
c. placing said adhesive onto said attachment surface;
d. imparting said indicia onto said outer label surface, said indicia identifying said contents; and
e. inserting said label within said sleeve opening in a manner such that said indicia is oriented to be visible through said window.

17. The method of claim 16, further comprising adapting said indicia in conjunction with changes in said contents.

18. A method for identification of contents contained within a cooler comprising:
a. removing contents from a paper or cardboard packaging and placing said contents within a cooler;
b. obtaining a cooler content identification system of claim 15;
c. placing said adhesive onto said attachment surface;
d. imparting said indicia by writing onto said outer label surface, said indicia identifying said contents; and
e. inserting said label within said sleeve opening in a manner such that said indicia is oriented to be visible through said window.

19. The method of claim 18, further comprising erasing and rewriting said in conjunction with changes in said contents.

20. A method for identification of contents contained within a cooler comprising:
a. removing contents from a paper or cardboard packaging and placing said contents within a cooler;
b. obtaining a cooler content identification system of claim 15;
c. placing said adhesive onto said attachment surface; and
d. inserting said label within said sleeve opening in a manner such that said indicia is oriented to be visible through said window.
